(19) United States
(12) Patent Application Publication
(10) Pub. No.: US 2025/0100392 A1
(43) Pub. Date: Mar. 27, 2025

(54) VEHICLE CONTROL SYSTEM AND METHOD

(71) Applicant: Transportation IP Holdings, LLC, Norwalk, CT (US)

(72) Inventors: Jeffrey John Wolff, Erie, PA (US); Henry Todd Young, Erie, PA (US); Jennifer Sobierajski, Erie, PA (US); Daniel Robert Wallace, Fulton, NY (US); Ibrahim Kacar, Erie, PA (US)

(73) Assignee: Transportation IP Holdings, LLC, Norwalk, CT (US)

(21) Appl. No.: 18/896,377

(22) Filed: Sep. 25, 2024

Related U.S. Application Data
(60) Provisional application No. 63/584,957, filed on Sep. 25, 2023.

(51) Int. Cl. B60L 15/20; B60K 6/46; B60L 5/24; B60L 5/28; B60L 15/00; H02J 3/14; H02J 3/24

(52) U.S. Cl. CPC B60L 15/20; B60K 6/46; B60L 5/24; B60L 5/28; B60L 15/007; H02J 3/14; H02J 3/24; B60Y 2200/92

(57) ABSTRACT

A system and a method for connecting a vehicle to an external source includes determining that a vehicle to be propelled by a drive system having one or more motors is to connect to an off-board power source while the one or more motors are powered by an onboard power source. The onboard power source is controlled to provide a determined amount of first electric energy to a first converter system. A second converter system is controlled to output an amount of second electric energy from the off-board power source within a designated threshold range. The second converter system is disposed between the off-board power source and the first converter system. The drive system receives power from the off-board power source responsive to the second converter system outputting the second amount of electric energy within the designated threshold range.

### CROSS-REFERENCE TO RELATED APPLICATIONS

The present application claims the benefit of and priority under 35 U.S.C. § 120 to U.S. Provisional Patent Application No. 63/584,957, titled VEHICLE CONTROL SYSTEM AND METHOD, filed Sep. 25, 2023, the disclosure of which is incorporated by reference in its entirety herein.

### BACKGROUND

### Technical Field

The subject matter described herein relates to controlling operation of vehicles having collector devices that can obtain electric current for powering the vehicles from off-board power sources.

### Discussion of Art

Some vehicles may be powered by electric current obtained from an off-board power source. For example, some mining vehicles, rail vehicles, buses, or the like, may be powered by coupling a collector device, such as a pantograph or a conductive shoe with a conductive pathway, such as an overhead catenary or an electrified rail.

The collector device may collect power through contact with the conductive pathway. The conductive pathway may extend along a route being traveled by the vehicle. The conductive pathway may power loads to the vehicle. The collector device may be spring-loaded to push a contact shoe up or down against the conductive pathway to draw the current needed to run the vehicle. Return current may run through the route being traveled. As the vehicle moves, the collector device may slide along the conductive pathway and may set up standing waves in the wires which break the contact and degrade current collection.

These vehicles may be dependent upon a continual connection with the conductive pathway, such as the catenary or electrified rail. For example, separation of the pantograph or conductive shoe from the catenary or rail may prevent conduction of electric current from the catenary or electrified rail to the pantograph or conductive shoe. This can cause power to not be delivered to motors or other loads of the vehicle, thereby resulting in undesirable and sudden deceleration of the vehicle. Additionally, upon re-connection of the pantograph or conductive shoe with the catenary or electrified rail, a rush of current may cause an undesirable acceleration of the vehicle. The pantograph or conductive shoe may separate from the catenary or electrified rail due to bouncing of the pantograph, the conductive shoe, or the vehicle; drooping or other bent sections of the catenary or electrified rail; damaged or deteriorated route surfaces; motors or other components being unable to fully extend the pantograph or lower the conductive shoe; the vehicle moving away from the route that has the catenary or the electrified rail.

It may be desirable to have a system and method that differs from those that are currently available.

### BRIEF DESCRIPTION

In accordance with one example or aspect, a method for connecting to an external source includes determining that a vehicle to be propelled by a drive system having one or more motors is to connect to an off-board power source while the one or more motors are powered by an onboard power source. The onboard power source is controlled to provide a determined amount of first electric energy to a first converter system. A second converter system is controlled to output an amount of second electric energy from the off-board power source within a designated threshold range. The second converter system is disposed between the off-board power source and the first converter system. The drive system receives power from the off-board power source responsive to the second converter system outputting the second amount of electric energy within the designated threshold range.

In accordance with one example or aspect, a method includes determining that a vehicle that is to be propelled by a drive system having one or more motors is to disconnect from an off-board power source while the one or more motors are being powered by the off-board power source. An onboard power source is controlled to provide a determined amount of first electric energy to a first converter system. A second converter system is controlled to output an amount of second electric energy from the off-board power source within a designated threshold range. The designated threshold range is less than the amount of first electric energy of the onboard power source. The drive system receives power from the onboard power source responsive to the second converter system outputting the second amount of electric energy within the designated threshold range.

In accordance with one example or aspect, a system includes a vehicle that is to be propelled by an electric drive system having one or more motors. The vehicle is to be powered by one of a first electric energy from an onboard power source or a second electric energy from an off-board power source. A collector device is coupled to the vehicle, and the vehicle receives the second electric energy from the off-board power source via the collector device. A controller having one or more processors controls the onboard power source to provide a determined amount of the first electric energy to a first converter system while the vehicle is being powered by the first electric energy of the onboard power source. The controller controls a second converter system to output an amount of second electric energy from the off-board power source. The second converter system is disposed between the off-board power source and the first converter system. The drive system receives power from the off-board power source responsive to the second converter system outputting the second amount of electric energy within the designated threshold range.

### BRIEF DESCRIPTION OF THE DRAWINGS

The subject matter may be understood from reading the following description of non-limiting embodiments, with reference to the attached drawings, wherein below:

FIG. 1 illustrates a side view of a vehicle having a collector device, in accordance with one example;

FIG. 2 illustrates a schematic view of a vehicle, in accordance with one example;

FIG. 3 illustrates a flowchart of a method for controlling operation of a vehicle, in accordance with one example;

FIG. 4 illustrates a schematic overview of a vehicle, in accordance with one example;

FIG. 5 illustrates a schematic overview of a vehicle, in accordance with another example;

FIG. 6 illustrates a flowchart of a method of connecting a collector device of a vehicle with a conductive pathway, in accordance with one example; and

FIG. 7 illustrates a flowchart of a method of disconnecting a collector device of a vehicle from a conductive pathway, in accordance with one embodiment.

### DETAILED DESCRIPTION

Embodiments of the subject matter described herein relate to vehicle control systems and methods that control operation of a vehicle having a collector device that receives, conducts, and/or inductively (and/or wirelessly) transfers electric current between a conductive pathway and power loads of the vehicle. The conductive pathway may be an off-board source of power for the vehicle. In one example, the collector device may be a pantograph of the vehicle that raises to contact an overhead catenary. As another example, the collector device may be a conductive shoe of the vehicle that lowers to contact an electrified rail. As another example, the collector device may be an inductive surface or pad that wirelessly transfers power through the inductive surface or pad. These collector devices can conduct electric current from the conductive pathway to motors of the vehicle to propel the vehicle along one or more routes. The vehicle may also have an onboard power source capable of providing current to motors to propel the vehicle along one or more routes. One or more embodiments of the subject matter described herein relate to systems and methods that control operation of the vehicle to limit negative impacts on operation and movement of the vehicle that may be caused by unintended separation of the collected device from the conductive pathway (e.g., to an extent that the collector device is unable to receive energy from the conductive pathway).

A suitable control circuit, or controller, may include an integrated circuit, a general purpose computing device, one or more processors, a memory device (e.g., forms of random access memory), a communications device (e.g., a modem, communications switch, or optical-electrical equipment).

In one embodiment, the control circuits, controllers or systems described herein may have a local data collection system deployed and may use machine learning to enable derivation-based learning outcomes. The control circuits may learn from and make decisions on a set of data (including data provided by various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used making determinations, calculations, comparisons and behavior analytics, and the like.

In one embodiment, the control circuit may include a policy engine that may apply one or more policies. These policies may be based at least in part on characteristics of a given item of equipment or environment. With respect to control policies, a neural network can receive input of a number of environmental and task-related parameters. These parameters may include, for example, operational input regarding operating equipment, data from various sensors, location and/or position data, and the like. The neural network can be trained to generate an output based on these inputs, with the output representing an action or sequence of actions that the equipment or system should take to accomplish the goal of the operation. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the control circuit may use evolution strategies techniques to tune various parameters of the artificial neural network. The control circuits may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models is obtained, they may be evaluated on their performance using a determined success metric. The best model is selected, and the vehicle control circuit executes that plan to achieve the desired input data to mirror the predicted best outcome scenario. Additionally, the success metric may be a combination of the optimized outcomes, which may be weighed relative to each other.

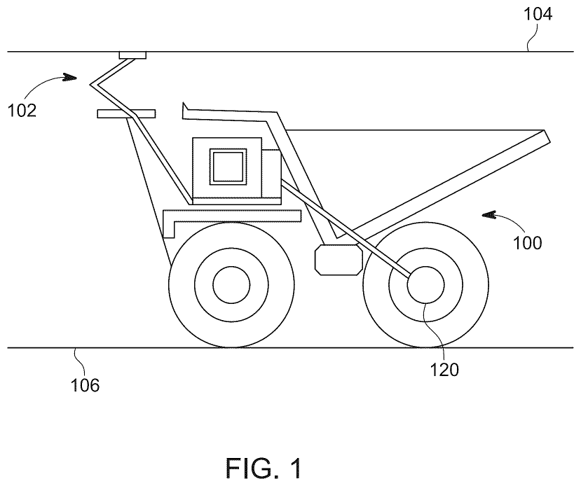

FIG. 1 illustrates one example of a vehicle 100 having a collector device 102 that may engage a conductive pathway 104. In one embodiment, the collector device may engage with the conductive pathway by making physical contact with the conductive pathway. In another embodiment, the collector device may engage with the conductive pathway by being within a determined distance away from the conductive pathway. In another embodiment, the collector device may engage with the conductive device responsive to a portion of the collector device being in physical contact with a portion of the conductive pathway. For example, a portion of the collector device may be in contact with or within a determined threshold distance away from the conductive pathway, such as to allow for inductive transfer of power from the conductive pathway to the collector device.

The collector device may selectively engage the conductive pathway during operation. For example, movement of the collector device may be controlled to enable the collector device to selectively and controllable engage with and/or disengage from the conductive pathway. The vehicle may travel along a route 106 such as a road, track, path, or the like. The conductive pathway may extend along the route or along a portion of the route. The conductive pathway may extend above the route, on the route, or alongside the route. The conductive pathway may provide energy to the vehicle that may be used to power loads of the vehicle. The conductive pathway may be an off-board source of power for the vehicle. The loads of the vehicle may include motors, lights, control systems, displays, air conditioning, and the like. In one example, the vehicle may be a mining vehicle, a trolley, an electric train, an electric bus, or an electric automobile. The vehicle may have wheels or tracks 120 positioned to engage the route being traveled by the vehicle.

In one example, the conductive pathway may be an overhead catenary line, as shown in FIG. 1. The conductive pathway may be an overhead trolley line, a traction wire, an overhead contract system, overhead equipment, an overhead line, or the like. In these embodiments, the collector device may be a pantograph that raises above the vehicle to contact or engage the conductive pathway, as discussed below. The conductive pathway may be positioned over the route and may be connected to feeder stations at regular intervals which provide electric power to the conductive pathway. The feeder stations may be electrically connected to a high-voltage electrical grid to provide electrical current and energy to the conductive pathway. The catenary line may engage an upper portion of the vehicle to provide the electric current to the vehicle.

In another example, the conductive pathway may be an electrified rail or rails over which the vehicle travels. The electrified rail may be a third rail that runs adjacent to or near a first rail and a second rail that make up the route. The electrified rail may engage a lower portion of the vehicle, for example a conductive shoe, to provide the electric current to the vehicle. In this example, the conductive shoe may be the collector device. The conductive shoe may lower or move laterally to contact or engage the third rail. The wheels may engage the first and second rail, while the conductive shoe may engage the third rail.

The collector device may be positioned at the upper or side portion of the vehicle, such as a pantograph coupled to the upper or side portion of the vehicle. In other examples, the collector device positioned at the upper portion of the vehicle may include a bow collector, a trolley pole, or the like. The collector device may extend to a position away from the vehicle to be in position to transfer energy between the conductive pathway and the collector device, and may retract to a position where the collector device is too far away from the conductive pathway for the transfer of energy therebetween. The collector device may extend to engage the conductive pathway to receive the electric current and provide the current to the vehicle. The collector device may be electrically conductive with the conductive pathway, but the collector device may include an insulated portion in contact with the vehicle. In one or more embodiments, the vehicle may transfer energy to the conductive pathway while the collector device is in the extended position and engages the conductive pathway. For example, the transfer of energy may be bi-directional, such that the conductive pathway may transfer energy to the vehicle and/or the vehicle may transfer energy to the conductive pathway (or to an alternative energy receiving device, to another vehicle, to another energy system, or the like).

In another example, the collector device may be positioned at the lower portion of the vehicle, such as a conductive shoe positioned at the lower portion of the vehicle. The conductive shoe may project laterally from the lower portion of the vehicle or may extend vertically downward away from the vehicle to engage the electrified rail. The conductive shoe may lower or extend to engage the electrified rail to receive the electric current and provide the current to the vehicle. The first and second rails of the route may be metal, such as steel. Where the first and second rails are steel, the first and second rails may act as an electrical return for excess current supplied to the vehicle. The first and second rails may act as a grounding force, dissipating the excess current or may act to transport the excess current to a facility, such as the feeder station or the electrical grid. In one example, a fourth rail may be used. The fourth rail may serve as the electrical return system, such that excess current is returned to the facility by the fourth rail.

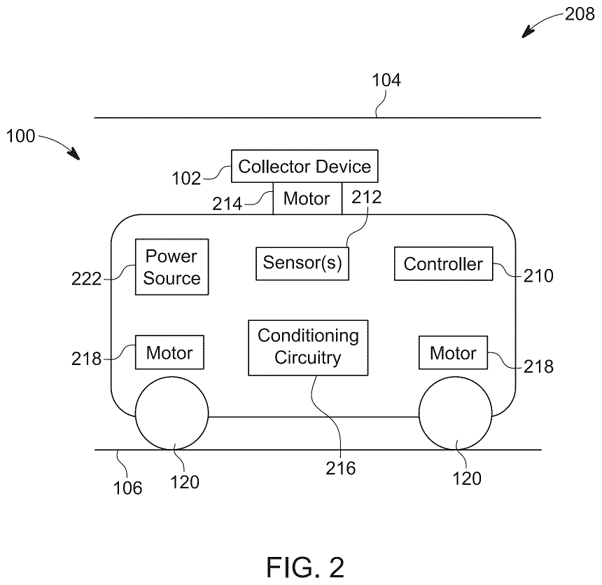

With continued reference to the vehicle shown in FIG. 1, FIG. 2 illustrates one example of a vehicle control system 208 of the vehicle. The vehicle control system may include a controller 210 and one or more sensors 212. The vehicle includes the collector device 102 that may extend away from the vehicle to contact the conductive pathway 104, one or more motors 218, a power source 222, and the wheels 120. Where the vehicle is travelling near the conductive pathway, the collector device may engage the conductive pathway to provide electric energy to power loads of the vehicle. However, the conductive pathway may not extend along the entirety of the route being travelled by the vehicle. Thus, where the vehicle is travelling along a portion of the route without the conductive pathway, the vehicle may receive power from the power source onboard the vehicle to power the loads. The controller may evaluate when and how much power to use from the offboard power source, for example the conductive pathway, and onboard power source.

The controller may represent hardware circuitry that may include and/or may be connected with one or more processors that may control operation of the vehicle control system as described herein. The processors may include microprocessors, microcontrollers, integrated circuits, field programmable gate arrays, or other logic devices that operate based on instructions stored on a tangible and non-transitory computer readable storage medium, such as software applications stored on a memory or database. In one embodiment, the controller can represent a vehicle controller or vehicle control unit. In one or more embodiments, the vehicle control system may include one or more input and/or output devices (e.g., control panel, switch, keyboard, microphone, touch screen, speaker, or the like), that allow an operator of the vehicle to control one or more operations of the vehicle controller, to communicate with the vehicle controller, to receive information (e.g., about the vehicle) from the vehicle control unit, or the like. The controller may include a single processor or multiple processors. All operations can be performed by each processor, or each processor may perform at least one different operation than one or more (or all) other processors). The processors may be in the same or different locations (such as by being disposed within or part of different devices).

In one embodiment, the controller or control system may have a local data collection system deployed that may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the controller or control system may include a policy engine that may apply one or more policies. These policies may be based at least in part on characteristics of a given item of equipment or environment. With respect to control policies, a neural network can receive input of a number of environmental and task-related parameters. These parameters may include an identification of a determined trip plan for a vehicle group, data from various sensors, and location and/or position data. The neural network can be trained to generate an output based on these inputs, with the output representing an action or sequence of actions that the vehicle group should take to accomplish the trip plan. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

The controller can use this artificial intelligence or machine learning to receive input (e.g., a location or change in location information associated with the conductive pathway), use a model that associates position(s) of the conductive pathway with different operating modes of the collector device to select an operating mode of the collector device of the vehicle, and then provide an output (e.g., the operating mode selected using the model). The controller may receive additional input of the change in operating mode that was selected, such as how the change in operating mode changes the position of the collector device relative to the conductive pathway and/or the vehicle, how the change in the position of the collector device changes an amount of energy that is transferred between the conductive pathway and the collector device, or the like, operator input, or the like, that indicates whether the machine-selected operating mode provided a desirable outcome or not. Based on this additional input, the controller can change the model, such as by changing which operating mode (and thereby a position of the collector device relative to the vehicle) would be selected when a similar or identical location or change in location is received the next time or iteration. The controller can then use the changed or updated model again to select an operating mode, receive feedback on the selected operating mode, change or update the model again, etc., in additional iterations to repeatedly improve or change the model using artificial intelligence or machine learning.

The one or more sensors of the vehicle control system may monitor mechanical or electrical characteristics of the conductive pathway, the collector device, or the electric energy that is transferred between the conductive pathway to the vehicle via the collector device. The sensors may be and/or may include electrical and/or mechanical sensors. The electrical sensors may include an ohmmeter measuring electrical resistance, a voltmeter measuring electrical potential in volts, an impedance analyzer measuring impedance, an ammeter measuring current, a thermometer measuring a temperature of the energy storage system, or the like. The electrical sensors may measure the potential or voltage of the conductive pathway, electric current conducted from the conductive pathway to the collector device, the power or wattage of the energy transferred from the conduct this pathway to the collector device, or the like.

The mechanical sensors may include an optical sensor (e.g., an infrared sensor, a proximity detector), a strain gauge, a speed sensor, a Hall effect sensor, an acoustic sensor (e.g., an ultrasonic sensor), a capacitive sensor, a photoelectric sensor, an inductive sensor, a laser distance sensor (e.g., Light Detection and Raging [“LIDAR”]), or the like. The mechanical sensors may measure the physical characteristics of the collector assembly, the vehicle, the conductive pathway, or a combination thereof. Additionally, the mechanical sensors may measure components of the collector assembly, the vehicle, or the conductive pathway. The mechanical sensors may measure a position or a maximum height of the collector device, a speed of the vehicle, a position of the vehicle or the collector device relative to the conductive pathway, a strain on the collector device or the conductive pathway, among other measurements.

The data sensed and/or obtained by the sensors may be used by the controller to detect when the vehicle may be connected to the conductive pathway and when the vehicle may be disconnected from the conductive pathway. For example, the sensor may be a voltmeter that may detect electrical characteristics of the conductive pathway while the vehicle is connected to the conductive pathway. Additionally, the data sensed and/or obtained by the sensors may be used by the controller to estimate or predict when the vehicle may be approaching an upcoming disconnection point from the conductive pathway. As one example, the sensor may be a laser distance sensor or optical sensor, and may sense characteristics about a location of the sensor relative to a location of the conductive pathway (e.g., a distance therebetween, etc.). The sensors may communicate this information to the controller. In one example, the conductive pathway may ramp up at an end of path. The sensor may be able to identify the ramp up as the end of the path and prepare the vehicle for disconnection. In one example, the conductive pathway may include edge of line identifiers. The sensors may be able to identify the edge of line identifiers which may indicate a potential disconnection of the vehicle from the conductive pathway. This may allow the controller to prepare the vehicle for the disconnection from the conductive pathway.

A collector device actuator 214 optionally may be provided to move the collector device toward or away from the conductive pathway. For example, the controller can control operation of the actuator to move the collector device away from the vehicle toward the conductive pathway so that the collector device may transfer energy with the conductive pathway. As another example, the actuator may extend the collector device beneath the vehicle or may move the collector device laterally away from the vehicle to a position where the collector device can transfer energy with the conductive pathway. In one or more embodiments, the actuator may be a motor or motoring device, a pneumatically controlled device, or the like.

The controller may control operation of the collector device by directing the collector device motor to move the collector device into engagement with the conductive pathway so that electric energy may be obtained from the conductive pathway. The electric energy, such as electric current, may be conducted from the conductive pathway, through the collector device, to conditioning circuitry 216 of the vehicle. The conditioning circuitry may include one or more rectifiers, inverters, switches, transformers, resistive elements, or the like. The conditioning circuitry may modify the current obtained from the conductive pathway prior to delivering or conducting the current that has been modified to the motors of the vehicle, to the onboard power source (e.g., a battery cell, engine and generator, engine and alternator, fuel cell, supercapacitor, or the like) that may store at least some of the modified current, or the like. The motors and conditioning circuitry can represent an electric drive system of the vehicle that operates to propel the vehicle along the route.

In one or more embodiments, the onboard power source can generate or create electric energy, such as electric current, to power loads of the vehicle, such as the motors. Examples of the onboard power source can include an engine and an alternator or generator, one or more batteries or batteries cells, one or more capacitor banks, one or more fuel cells, or the like.

The conductive pathway may operate as an off-board source of power when the collector device is engaging the conductive pathway. In one example, when the collector device engages, is engaged with, or is within a threshold distance range of the conductive pathway in order to transfer energy between the conductive pathway and the collector device, the conductive pathway may be a primary source of power for the vehicle and the onboard power source may be a secondary source of power for the vehicle. In another example, when the collector device engages or is engaged with the conductive pathway, the conductive pathway may be a secondary source of power for the vehicle and the onboard power source may be a primary source of power for the vehicle. In one example, when the collector device does not engage the conductive pathway, the onboard power source may be the primary source of power of the vehicle. As used herein, a primary source of power may include the power source that provides the most power to the vehicle at a given time. As used herein, a secondary source of power may include the power source that provides an amount of power less than the primary source of power to the vehicle at a given time.

In one example, the amount of electric energy supplied by the onboard power source may be less than a power capacity at which the off-board power source may be able to provide the electric energy. For example, the conductive pathway may provide power to the vehicle that is greater than an amount of power that the onboard power source is capable of providing. The electric energy received from the conductive pathway may exceed a limit or threshold that the vehicle is capable of receiving, and may cause one or more safety switches of the circuit system to open. In order to preserve the electrical connection between the conductive pathway and the vehicle when the vehicle is to receive electric energy from the conductive pathway, the controller may need to control one or more operating settings of the vehicle to prepare the vehicle to receive the increased electric energy from the conductive pathway.

As described herein, the controller can control operation of the onboard power source to supplant, augment, or replace the current conducted from the conductive pathway or off-board power source to the motors. In one example, the controller may control an acceleration or a deceleration of the vehicle to within a designated threshold range based at least in part on a combined amount of (a) the electric energy supplied by the conductive pathway or off-board power source and (b) the electric energy supplied by the onboard power source. For example, to avoid a large in-rush of the electric energy from the conductive pathway with the electric energy of the conductive pathway having a greater voltage than the onboard power source, the controller may control one or more systems of the vehicle (e.g., a propulsion system) to increase or ramp up the amount of energy generated by the onboard power source, such as to be within a designated threshold range of the voltage of the electric energy from the conductive pathway. For example, the electric energy from the conductive pathway may be about 2500 volts, about 5000 volts, about 7000 volts, or the like. The controller may control the onboard power source to provide onboard electric energy that may be about 50-100 volts less than the electric energy from the conductive pathway.

When the collector device disconnects from the conductive pathway, the amount of off-board energy the vehicle is receiving decreases. When the off-board energy received by the vehicle decreases, the controller may need to adjust or increase the amount of energy supplied by the onboard power source to maintain consistent power and performance of the vehicle. The controller may blend the energy received from these different sources to that at least a lower designated threshold of electric energy or power is available or conducted to the loads. This can help prevent any loads from being unable to operate due to a shortage of electric energy.

In operation, the controller may monitor outputs from one or more of the sensors to detect whether the collector device has disconnected or has begun disconnection from the off-board source of power (e.g., the conductive pathway). The sensors may output optical information from an optical sensor, electrical characteristics from a voltage or current sensor, strain output from a strain gauge, or the like. In one example, the sensor may measure a position of the collector device (e.g., relative to an exterior portion of the vehicle, relative to the conductive pathway, or the like) to determine whether the position of the collector device is beyond a threshold distance (e.g., extended away from a portion of the vehicle). In one example, the sensor may measure a height of the conductive shoe to determine whether the height of the conductive shoe is below a threshold depth below the vehicle.

Additionally, the controller may monitor outputs from one or more of the sensors to predict an upcoming disconnection event. This may allow the controller to adjust operation of the vehicle accordingly for the upcoming disconnection. The sensors may measure the speed and/or acceleration of the vehicle, a lateral position of the collector device (e.g., whether the collector device is centered or offset from the conductive pathway), the extension of the collector device, an edge or end of the conductive pathway, the location of the vehicle, a strain on the collector device or the conductive pathway, or the like. The controller may use one or more of the outputs from the sensor(s) to detect when and/or where the collector device may connect or disconnect from the conductive pathway.

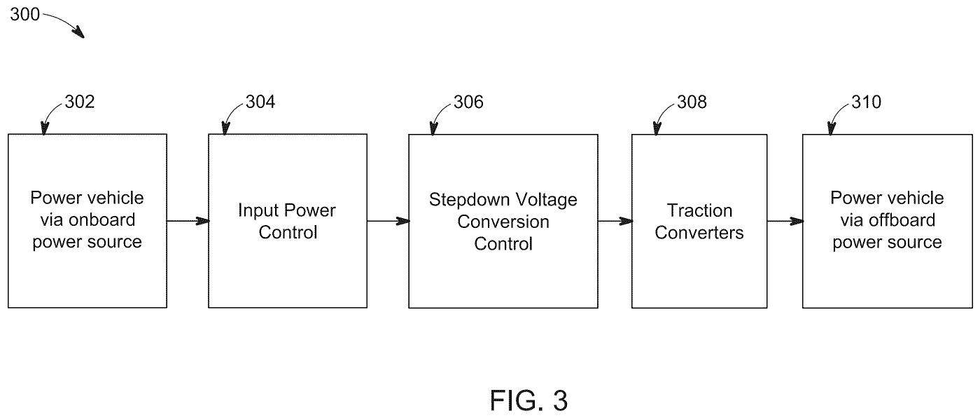

FIG. 3 illustrates one example of a flowchart of a method 300 for controlling operation of a vehicle during a connection event with an off-board power source. The vehicle may be propelled by an electric drive system having one or more motors. In one example, the off-board power source is a conductive pathway, and a collector device of the vehicle may connect or engage with the conductive pathway. At step 302, the vehicle system may be powered by an onboard power source. For example, a first amount of electric energy may be provided to the motors of the vehicle to power the vehicle. In one or more example, it may be determined and/or detected that the collector device of the vehicle is to be moved into a position where the vehicle may be electrically coupled with the off-board power source. At step 304, to prepare for the vehicle to be electrically coupled with the off-board power source, the controller may control one or more components and/or systems of the vehicle to prepare for the vehicle to receive a second electrical energy from the off-board power source. For example, the controller may control a circuit breaker, filters, inductors, contactors or switches, may monitor voltage and/or current outputs or measurements, or the like. For example, the controller may control one or more circuit components to provide a determined amount of the first electric energy from the onboard power source to a first converter system (e.g., a common converter of the vehicle). In one embodiment, the amount of the first electric energy from the onboard power source may be based at least in part on an anticipated or expected amount of energy the controller is expecting to receive from the off-board power source.

At step 306, responsive to the controller preparing the circuit components of the vehicle, the controller may control a second converter system (e.g., a stepdown voltage converter system) to control an amount of the second electric energy the vehicle receives from the off-board power source. For example, the second converter system may control and/or change one or more characteristics of the second electric energy that is received from the off-board power source. The second converter system may be a direct current to direct current (DC to DC) converter system and may include or be associated with transformer(s), inductors, may be isolated or a non-isolated converter system, or the like. In one or more embodiments, the controller may control the second converter system to control voltage and/or current outputs and/or measurements of the second electric energy from the off-board power source.

At step 308, the controller may control operation of the vehicle, the first converter system, the second converter system, or one or more other electrical components of the vehicle, to modify the second electric energy obtained from the off-board power source in order for the motors (or other loads of the vehicle) to be able to use the second electric energy. For example, the DC current of the second electric energy from the second converter system (e.g., the stepdown voltage converter system) may be modified or otherwise converted (e.g., to variable frequency alternating current, or the like) to create a stable toque of the vehicle having variable frequency and/or amplitude.

At step 310, the modified second electric energy may be provided to the motors and/or one or more loads of the vehicle to power one or more components and/or systems of the vehicle. Optionally, at least a portion of the modified second electric energy may be stored within the onboard power source (e.g., a battery or battery cell, a capacitor bank(s), or the like), that the vehicle may use at a later time of operation.

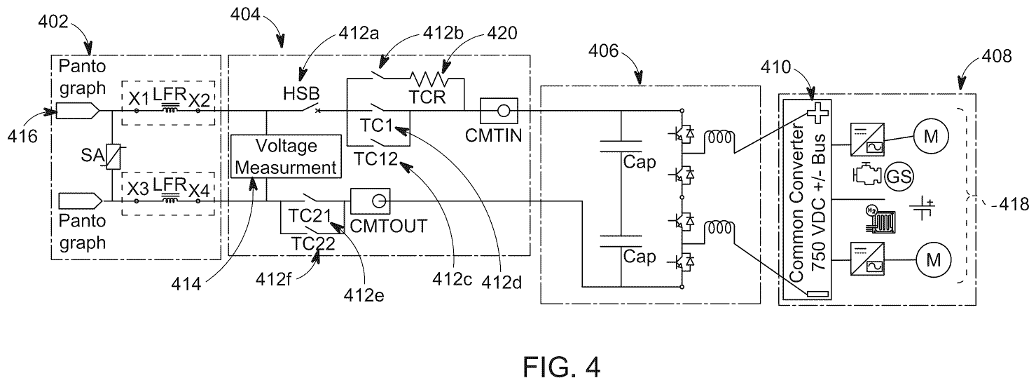

FIG. 4 illustrates a schematic overview of a vehicle, in accordance with one example. The schematic shown in FIG. 4 is for illustrative purposes only, and in alternative embodiments, the schematic of the vehicle may include additional and/or alternative components, may be devoid one or more of the components illustrated in FIG. 4, the components may have an alternative arrangement, or the like. The sensors, discussed above, may measure electrical characteristics of the electric current conducted to the vehicle from the conductive pathway and through the collector device. The controller may receive a measurement from the sensors, for example a current between the collector device and the conductive pathway. The controller may confirm whether the measured current is within an acceptable range for operating the vehicle in a trolley mode. As used herein, a trolley mode may be where the collector device of the vehicle engages the conductive pathway (e.g., directly and/or indirectly) such that the conductive pathway provides at least some electric energy to the vehicle. In one example, there may be an incoming current range of the electric energy from the conductive pathway. For example, the current of the incoming electric energy from the conductive pathway may need to be within a predetermined range in order for the vehicle to be able to receive, use, and/or store the incoming electric energy. If a measured current from the conductive pathway is outside of the incoming current range, operation of the vehicle in the trolley mode may be inhibited. The incoming current range may vary based on a voltage of the electrification system. Additionally, the vehicle may include a sensor to identify ground faults.

In the illustrated embodiment, the vehicle includes a collector device 402 having one or more pantographs 416 electrically coupled with a collector control system 404. In one or more embodiments, the collector control system may be referred to as a trolley connection control group, and may include additional and/or alternative equipment as shown. In the illustrated embodiment, the collector control system includes a voltage sensor 414, a resistor 420, and plural switches 412A-F that are all in an open position. In one or more embodiments, the switch 412A may be referred to as a circuit breaker switch (e.g., a high speed circuit breaker). Optionally, the system may be devoid the switches 412C-D and/or devoid the switches 412E-F. Optionally, two or more of the switches may be arranged in series, or alternatively the system may include a single switch or contactor.

The vehicle also includes a vehicle control system 408 that includes a first converter system 410 (e.g., a common converter system of the vehicle). The first converter system may convert or modify first electric energy received from one or more onboard power sources 418 (e.g., engine, battery, fuel cell, or the like) to generate torque to move the vehicle. In the illustrated embodiment, the first converter system receives at least some first electric energy from plural onboard power sources, but alternatively may receive energy from a single onboard power source. In one embodiment, each of the plural onboard power sources may provide a different amount of first electric energy to the first converter system. Additionally or alternatively, two or more of the onboard sources may provide a common or substantially same amount of the first electric energy to the first converter system.

A second converter system 406 is disposed between the first converter system of the vehicle control system and the collector control system. In the illustrated embodiment, the second converter system includes capacitors, inductors, transistors (e.g., bipolar transistors, insulated-gate bipolar transistors, or the like). In one or more embodiments, the second converter system may be used as a tool by the vehicle to prepare the first converter system to receive electric energy from the conductive pathway. For example, the second converter system and the collector control system (e.g., of the collector device) may be controller to allow the first converter system, receiving the first electric energy at a first voltage, to prepare to receive the second electric energy at a second voltage that is greater than the first voltage. Preparing the first converter system to receive the increased voltage from the conductive pathway enables the vehicle to smoothly transition from being powered by the onboard power sources to being powered by the off-board power source(s) and without causing damage to electrical components of the vehicle, without disrupting operation of the vehicle, or the like.

In one or more embodiments, the vehicle may include one or more additional and/or alternative electrical components that allow the transmission of power between the off-board power source and the vehicle. As one example, one or both of the first or second converter systems may be alternating current to alternating current (AC to AC) converters, may be direct current to alternating current (DC to AC) converters, may be alternating current to direct current (AC to DC) converters, may be a pulsed DC system, or the like. For example, in one embodiment, the power that is passed through the collector device to the vehicle may be in the form of an alternating current that may need to be converted to direct current to be received and/or used to power one or more loads of the vehicle. In another embodiment, the power passed through the collector device may be a direct current, that may need to be converted to alternating current to be used to power one or more loads of the vehicle. In one or more embodiments, the direct current may be actively or passively rectified, with or without control of one or more of the first or second converter systems. In one or more embodiments, the pulsed DC may use a DC to DC converter that separates the current into onboard portions of the current and off-board portions of the current.

The transmission of DC power may include voltages that are greater than 1000 Volts DC, that are about 1800 VDC, about 2600 VDC, about 6600 VDC, or the like. The larger or greater DC power may be used to power high power loads of the vehicle (e.g., traction loads, etc.), and lower or lesser DC power may be used to power low power loads of the vehicle (e.g., auxiliary loads, blowers, energy storage devices, etc.). The transmission of AC power may include voltages that are greater than 1000 VAC, about 7200 VAC, about 10 kilo-Volts AC, about 25 KVAC, or the like. The transmission of pulsed DC power may include voltages that are greater than 1000 VDC, greater than 5200 VDC, or the like.

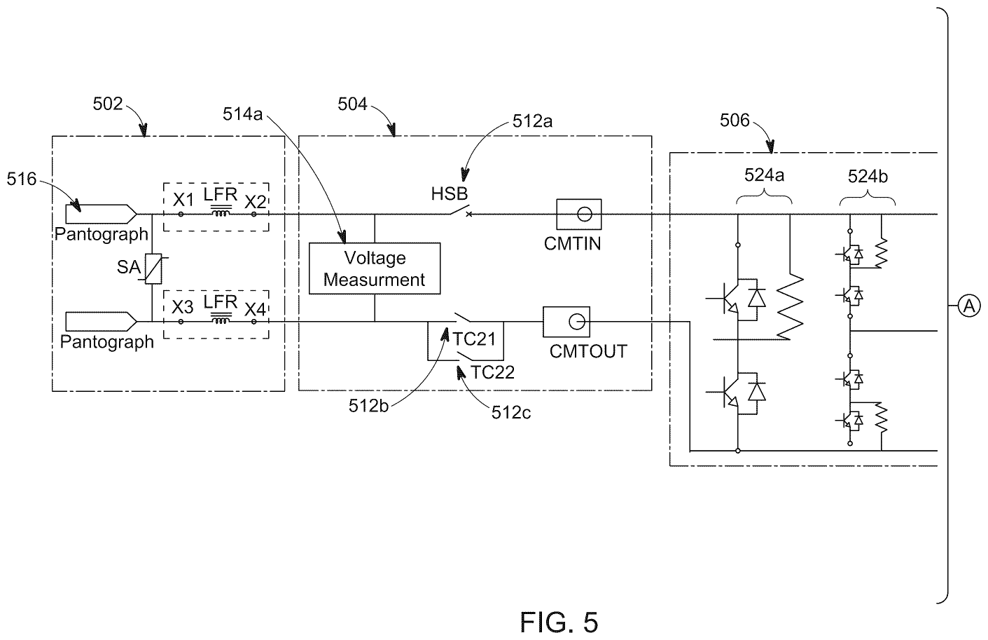

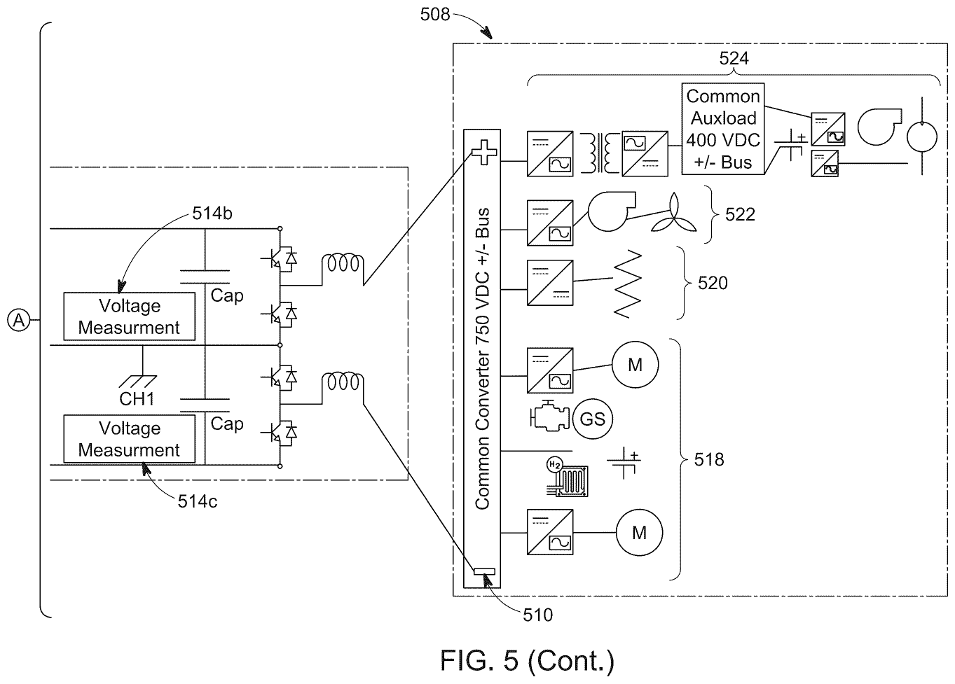

FIG. 5 illustrates a schematic overview of a vehicle, in accordance with another example. The schematic shown in FIG. 5 is for illustrative purposes only, and in alternative embodiments, the schematic may include additional and/or alternative components, may be devoid one or more of the components illustrated in FIG. 5, the components may have an alternative arrangement, or the like. In one or more embodiments, a portion of the schematic illustrated in FIG. 4 may be combined with a portion of the schematic illustrated in FIG. 5. Optionally, the schematic shown in FIG. 4 may include one or more portions of the schematic shown in FIG. 5; or the schematic shown in FIG. 5 may include one or more portions of the schematic shown in FIG. 4. Optionally, the electrical schematic of the vehicle may be different than the schematics shown in FIGS. 4 and 5.

Like the schematic shown in FIG. 4, the vehicle includes a collector device 502 having one or more pantographs 516 electrically coupled with a collector control system 504. In the illustrated embodiment, the collector control system includes a voltage sensor 514A and plural switches 512A-C that are all shown in an open position. In one or more embodiments, the switch 512A may be referred to as a circuit breaker switch (e.g., a high speed circuit breaker). In one or more embodiments, the switches 512B, 512C may be referred to as pre-charge contactors, and may enable unidirectional power flow between the collector device and the vehicle. In alternative embodiments, the collector control system may be devoid the pre-charge contactors 512B, 512C, and may instead include a bidirectional power flow converter. In one or more embodiments, the collector control system may be devoid one or more of the plural switches, and alternatively may include a fuse or other breaker equipment.

The vehicle also includes a vehicle control system 508 that includes a first converter system 510 (e.g., a common converter system of the vehicle). The first converter system may convert and/or modify first electric energy received from one or more onboard power sources 518. In one or more embodiments, the onboard power sources can include and/or represent an engine, a traction motor, battery, fuel cell, or other energy source. Optionally, the onboard power sources can represent a DC to AC converter that generates torque to move a vehicle. In the illustrated embodiment, the first converter system receives at least some first electric energy from plural onboard power sources, but alternatively may receive energy from a single onboard power source. In one embodiment, each of the plural onboard power sources may provide a different amount of first electric energy to the first converter system. Additionally or alternatively, two or more of the onboard power sources may provide a common or substantially same amount of the first electric energy to the first converter system.

In one or more embodiments, the vehicle control system may include one or more auxiliary loads 522 that are operably coupled with the first converter system 510. The auxiliary loads may include and/or represent fans (e.g., cooling fans of the vehicle), battery charger devices, hydraulic pumps, or the like. The auxiliary loads may be DC and/or AC loads, may be multi-phase or single-phase, may be isolated or non-isolated loads, or any combination therein.

In one or more embodiments, the first converter system 510 may be operably coupled with one or more resistor devices 520, such as grid resistors, choppers, or the like. The one or more resistors may be single-phase and/or multi-phase, may be and/or include high side chopper(s) and/or low side chopper(s), or the like. In one or more embodiments, the resistors may be operably coupled with and provide power to a grid blower (not shown), or the like.

In one or more embodiments, the first converter system 510 may be operably coupled with a DC to DC chopper link 524. For example, the chopper link may be capable of dissipating excess power that is transferred from the conductive pathway 104 to the vehicle via the collector device 502. The chopper link may be configured and/or capable of receiving and/or isolating link voltages and/or multiple loads. In one or more embodiments, the chopper link may include one or more choppers, crowbar circuits, energy storage devices, or the like. In one or more embodiments, the chopper link may be engaged and/or controller to have control frequencies between about 800 Hz and 20 kHz. For example, the chopper link may be capable of controlling frequencies that are greater than frequencies that the traction motor of the onboard power source is capable of handling. Optionally, the operation frequency of the chopper link may be increased and/or decreased, such as based on an operating condition of the vehicle, based on an amount of power the conductive pathway is capable of providing, or the like. Optionally, the chopper link may be preloaded to a determined preloaded frequency, a preloaded dampening capability, or the like.

The vehicle includes a second converter system 506 that is disposed between the first converter system of the vehicle control system and the collector control system. In one or more embodiments, the second converter system may be referred to as a stepdown voltage converter system. In the illustrated embodiment, the second converter system includes capacitors, inductors, transistors (e.g., bipolar transistors, insulated-gate bipolar transistors, or the like), one or more choppers, or the like. In one or more embodiments, one or more choppers of the second converter system may be capable of dissipating energy received by the second converter system, such as before the energy is transferred to the traction load of the first converter system. Optionally, the choppers of the second converter system may be capable of discharging capacitors associated with the second converter system, that may be dissipated to grids of the vehicle system. In one or more embodiments, the choppers may be semi-link choppers, full link choppers, or the like.

In one or more embodiments, the second converter system may include a first grid system 524A and a second grid system 524B. The first and second grid systems are for illustrative purposes only, and in alternative embodiments, may have one or more alternative configurations, alternative arrangements, may be devoid portions of one or more of the grid systems, or any combination therein. In one or more embodiments, the first and/or second grid systems may allow the second converter system to operate as a boost converter that is capable of boosting the capacitance of the second electric energy (e.g. from the off-board power source) to match a voltage of the second electric energy with a voltage of the first electric energy from the first converter system. Alternatively, the first and/or second grid systems may boost the capacitance of the first electric energy to match a voltage of the first electric energy with a voltage of the second electric energy from the off-board power source. In one or more embodiments, the second converter system may include one or more voltage sensors 514B, 514C configured to measure or otherwise detect a voltage of the first electric energy from the first converter system and/or a voltage of the second electric energy from the off-board power source.

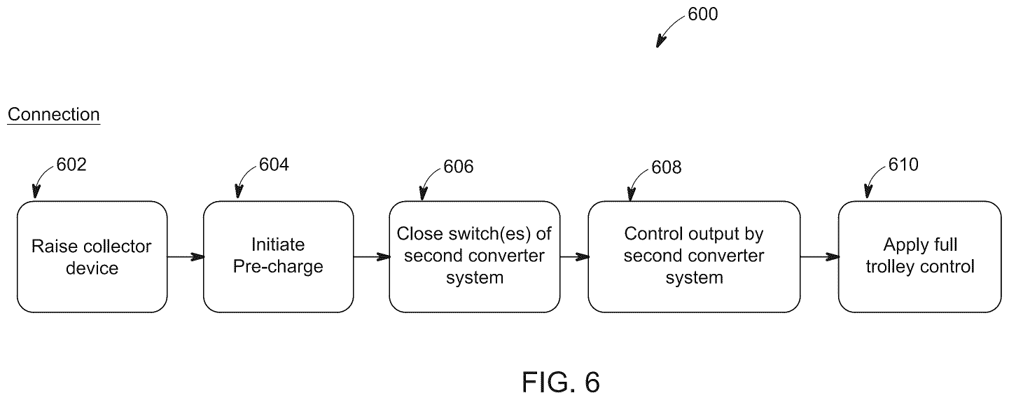

FIG. 6 illustrates one example of a method 600 for connecting the collector device of the vehicle with the conductive pathway. The method may represent a basic, traditional, expected, or normal connection event. For example, the vehicle may be traveling along a portion of a route without a conductive pathway, and the vehicle may rely on the onboard power supply to power the loads of the vehicle. When the vehicle approaches an upcoming portion of the route that includes the conductive pathway, the controller may prepare the vehicle for connection with the conductive pathway. For example, the connection event may be anticipated, expected, planned for, or the like.

In order to prepare the vehicle for connection with the conductive pathway, in one or more embodiments, the vehicle may be required to be moving along a route at a speed that is within a threshold range. The threshold range may have a lower speed limit (e.g., that is about 3 miles per hour (mph), about 5 mph, about 10 mph, or the like) and an upper speed limit (e.g., that is about 10 mph, about 15 mph, about 25 mph, or the like). Additionally or alternatively, the controller may control or change a position of the collector device by controlling operation of the collector device motors. For example, the position of the collector device may be about centered with an expected location of the conductive pathway. Additionally or alternatively, the position of the vehicle on the route may be controlled and/or changed so that the position of the vehicle is substantially aligned with an entrance area of a trolley line system (e.g., the upcoming portion of the route that includes the conductive pathway). Additionally or alternatively, one or more switches or contactors of the vehicle control system (shown in FIGS. 4 and 5) may be closed, such that only the onboard power sources are providing power to the loads of the vehicle. Optionally, additional and/or alternative steps may be taken to prepare the vehicle to receive electric energy from the off-board power source.

At step 602, the position of the collector device (e.g., a pantograph) may be changed to move the collector device away from the vehicle and towards the conductive pathway. For example, an extended position of the collector device may be controlled relative to an adjacent conductive pathway. This may allow the collector device to be in position to engage the conductive pathway. In another example, the collector device may be the conductive shoe and the conductive pathway may be the electrified rail. A position of the conductive shoe may be controlled to control a distance between the conductive show relative to an electrified conductive body. In one embodiment, an operator (onboard and/or off-board the vehicle) may manually change an input (e.g., a directional lever) to control movement of the collector device to move to a predetermined extended position in order for the collector device to make contact with or engage with the conductive pathway.

At step 604, responsive to the collector device (e.g., the pantograph) making contact with the conductive pathway (e.g., the off-board power source), while one or more switches or contactors of the second converter system are closed, and a voltage of the conductive pathway is detected (e.g., by one or more sensors of the vehicle), a pre-charge event of the vehicle may be initiated. For example, a resistor of the second converter system (shown in FIG. 4) may be pre-charged to be within a designated voltage threshold range. The designated voltage threshold range may be based at least in part on the detected voltage of the conductive pathway. For example, the designated voltage threshold range may be about 50 volts (V) to about 100V above the detected voltage of the conductive pathway. Optionally, the designated voltage threshold range may be about 20V to about 40V, from about 20V to about 100V, or the like. For example, the second converter system may be pre-charged, prepared, ramped up, or the like, to receive electric energy from the conductive pathway that has a greater voltage than the electric energy from the onboard power source once one or more switches or contactors of the second converter system are closed and the vehicle begins receiving electric energy from the conductive pathway.

In one or more embodiments, while the second converter system is being pre-charged to the designated voltage threshold range, the pre-charge event may also include controlling the one or more onboard power sources to provide a determined amount of the first electric energy to the first converter system. For example, a voltage of the one or more onboard power sources may be increased while a capacitance of the second converter system is being pre-charged (e.g., to reach the designated voltage threshold range). For example, the voltage of the first converter system may be increased to support loads of the vehicle (e.g., traction loads) while the second converter system is being pre-charged. In one or more embodiments, the speed of the engine may be increased to a designated speed to provide a determined amount of the first electric energy to the first converter system. The onboard power source(s) may power the drive system of the vehicle until the second converter system outputs the second electric energy that is within the designated voltage threshold range. In one or more embodiments, the first electric energy that is provided by the onboard power source(s) is based at least in part on a voltage capability of the off-board power source.

At step 606, responsive to the second converter system reaching the designated voltage threshold range, and the vehicle is prepared to receive the on-rush of current from the off-board power source, one or more switches or contactors of the second converter system may be closed. At step 608, the output of the second electric energy from the conductive pathway (e.g., that is within the designated voltage threshold range of about 50 v to about 100 v above the detected voltage of the onboard power source) from the second converter system is directed to the first converter system. For example, the first converter system may receive the first electric energy from the onboard power source(s) and the second electric energy from the second converter system. Because the voltage of the second electric energy from the off-board power source is greater than the voltage of the first electric energy (e.g., by about 50 volts to about 100 volts), the first converter system may automatically provide or direct at least some of the second electric energy (having the greater voltage) to one or more loads of the vehicle (e.g., traction loads, auxiliary loads, etc.).

At step 610, responsive to a load current at the first converter system being achieved from the second converter system, the onboard power sources may be controlled to be ramped down to determined speed and/or torque levels, and full trolley control of the vehicle may be applied. For example, one or more switches or contactors of the collector control system (e.g., the collector control system 404 shown in FIG. 4 and/or the collector system 504 shown in FIG. 5) may be closed, and the vehicle may receive power from the off-board power source. In one or more embodiments, one or more sensors of the vehicle may monitor an electric current that is conducted from the conductive pathway (e.g., a catenary or electrified conductive body) to the collector device (e.g., a pantograph or conductive shoe) while the switches or contactors of the second converter system and the collector control system are closed.

In one or more embodiments, after trolley mode is achieved and the vehicle is receiving power from the conductive pathway, the onboard power source(s) may ramp down output. For example, the off-board power source is configured to automatically transition to providing power to control operation of the vehicle responsive to the second converter system outputting the second amount of electric energy that is within the designated voltage threshold range. Additionally or alternatively, after trolley mode is achieved, the controller may control the amount of the first electric energy that is supplied to the first converter system by the onboard power sources to be less than a power capability of the off-board power source, and thereby, reduce an amount of power that is generated by the motors that are electrically coupled to the drive system of the vehicle. For example, if the motors of the vehicle operate at about 1200V, the controller may reduce the amount of power provided by the onboard power sources to be less than 1200V, and may increase the amount of power provided by the second converter system and the off-board power source to be greater than 1200V (e.g., to be about 1250V). The greater power provided by the off-board power source may be used to power loads of the vehicle.

In one or more embodiments, ramping down the output by the onboard power sources may reduce an engine speed to an engine trolley speed, which may be a target speed for the engine when the collector device is engaged with the conductive pathway, is receiving the second amount of electric energy from the off-board power source, and the vehicle is operating in trolley mode.

In one or more embodiments while the vehicle is operating in trolley mode and receiving at least some power from the off-board power source, one or more operating settings of the vehicle may be controlled to maintain the trolley mode connection. For example, the accelerator pedal of the vehicle may need to be depressed to a minimum determined depressed state (e.g., at least 25%, at least 30%, or the like) to remain in trolley mode. Optionally, the vehicle may include a cruise control setting, which may need to be engaged or applied to maintain a minimum speed of movement of the vehicle. Optionally, a directional lever that allows the operator to control movement of the connector device may need to be positioned in a loaded position (e.g., so the connector device maintains contact with the conductive pathway). In one or more embodiments, sensors of the vehicle may monitor a voltage of the second electric energy from the off-board power source, and the second converter system may regulate and/or maintain a traction link voltage to be within a determined range while the vehicle operates in trolley mode.

Typically, a vehicle may operate in the trolley mode for a portion of a trip. The vehicle may operate in the trolley mode for the entirety of the trip, however, a vehicle often may be in the trolley mode for between 30 seconds and 10 minutes. As such, the vehicle, and the components of thereof, may need to effectively disconnect from the conductive pathway and exit the trolley mode. For a normal disconnection of the collector device of the vehicle from the conductive pathway, a closed loop control system may be used. In another example, an open loop control system may be used. Various parameters may be measured by sensors and communicated to the controller. The controller may use the parameters to determine the state of the disconnection of the vehicle from the conductive pathway. In one example, one parameter is the current of the collector device. The current may be read by current sensors within the vehicle, such as an ammeter. The vehicle may include a rectifier that converts alternating current (AC) to direct current (DC). The DC may be used to power the loads of the vehicle. The current of the rectifier output may be read. The current of the rectifier output may be the current that is currently available to the vehicle.

In one or more embodiments, while the vehicle is operating in a steady state trolley mode (e.g., trolley mode is achieved, and the vehicle is being powered by the off-board power source), the second converter system (e.g., the step-down converter) may continue to operate to control a voltage level of the second electric energy from the off-board power source relative to a voltage level of the first electric energy from the first converter system. For example, the voltage of the second electric current does not match the voltage of the first electric energy, and the second converter system continues to convert the voltage level of one of the first or second electric energy to match the voltage level of the other of the first or second electric energy.

In one or more embodiments, while the vehicle operates in the trolley mode, the vehicle may be subject to and/or exposed to a link voltage oscillation in the system. The link voltage oscillation may occur as a result of one or more of a change in the catenary link voltage responsive to an increased inductance of line inductors in the system. For example, the link voltage oscillation may occur as a result of a bounce by a catenary, by one or more other vehicles being operably coupled with and/or separated from the catenary line, or the like. The second converter system, the first converter system, and/or the vehicle control system may include one or more systems or components that provide a pathway to get rid of oscillations of the voltage. If a voltage level of the traction converter is the same or substantially the same as the voltage level of the off-board power source, the traction load may be capable of handling oscillations in the voltage. However, if the voltage levels of the traction converter and off-board power source are different, one or more alternative components and/or systems may be required to dissipate the oscillations of the voltage. The conversion of the oscillation voltage may need to be controlled. In one or more embodiments, controlling the link oscillations may include actively detecting the frequency of the oscillation and applying an inverse voltage waveform to the DC link by substantially equivalent power to the grid and/or inverters, by auxiliary power, changing an available power sink or energy storage device, or the like.

In one or more embodiments, one or more systems and/or components of the first and/or second converter systems may control the link oscillation, such as by providing a path for dissipation of the excess power caused by the link oscillation. As one example, traction inverters of the vehicle control system (e.g., the vehicle control system 408 and/or 508) may be used to mitigate, dampen, lessen, or otherwise control an amount or level of link oscillations.

As another example, the choppers and/or grids of the vehicle may be used to mitigate, dampen, lessen, or otherwise control an amount or level of link oscillations. In one or more embodiments, the choppers may be capable of dissipating power that has a higher frequency relative to a lower frequency that the traction motors are capable of dissipating. The choppers may be controlled to engage responsive to detection of a link oscillation. In one or more embodiments, the choppers may be controlled and/or setup to clip a positive side of the link oscillations engaging when the link oscillation voltage is greater than a DC voltage of the first electric energy. Optionally, the choppers may be controlled and/or setup to engage and a predetermined power to reduce the link oscillation voltage to a predetermined level (e.g., twice the oscillation amplitude, or the like), and also counteract the oscillations on the positive and negative side.

In one or more embodiments, the choppers of the vehicle control system and/or second converter systems may be capable of controlling and/or dampening all of the oscillation voltages. Optionally, the choppers may be capable and/or controlled to dampen a portion of the link oscillation voltages, and the remaining portion of the link oscillation voltages may be dampened by another system or component of the vehicle control system.

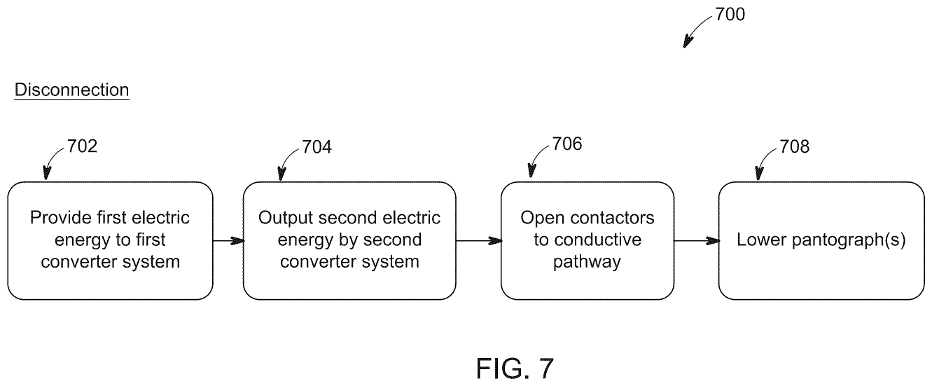

FIG. 7 illustrates one example of a method 700 of disconnecting the collector device of the vehicle from the conductive pathway. The disconnection event may be a planned event, an anticipated or expected event, a normal event, or the like, and may occur when an operator or controller of the vehicle is aware of an upcoming disconnection, such as a planned disconnection. One aim of the normal disconnection may be a safe, smooth transition that does not damage the components of the vehicle or the conductive pathway, that smoothly transitions the vehicle from being controlled via electric energy of the conductive pathway to being controlled via electric energy of the onboard power sources without disrupting operation of one or more systems or components of the vehicle, or the like.

At step 702, the controller may control operation of one or more of the onboard power sources to provide a determined amount of the first electric energy to the first converter system while decreasing the off-board power source. For example, the engine speed may be increased to increase the amount of the first electric energy generated onboard the vehicle, more energy may be obtained from batteries onboard the vehicle, or the like, while less power may be obtained from the off-board power source. By increasing the engine speed (e.g., to a full rated speed), the engine may be able to supplant or compensate for the decrease in power when the collector device disconnects from the conductive pathway. Said another way, when the vehicle disconnects from the conductive pathway, the second electric energy supplied by the conductive pathway to the vehicle may be lost. The second electric energy may be supplanted or replaced by the first electric energy provided by the engine or another onboard power source.

In one or more embodiments, the method may include reducing a traction torque of a motor of the vehicle. In one example, the reduction of the traction torque may occur 20 milliseconds (MS) after the motor speed is increased.

At step 704, the output of the second electric energy by the second converter system may be controlled to be within a designated threshold range that is lower than a determined threshold value based at least in part on the electric energy provided by the onboard power sources. For example, the designated threshold range may be about 50V to about 100V less than the voltage output by the first converter system. For example, a voltage of the second electric energy may be less than a voltage of the first electric energy by about 50V to about 100V. Because the voltage of the second electric energy from the off-board power source is less than the voltage of the first electric energy from the onboard power source, the first converter system may begin to automatically provide or direct at least some of the first electric energy (having the greater voltage) to one or more loads of the vehicle (e.g., traction loads).

At step 706, one or more contactors or switches of the vehicle may be opened, and the vehicle may be prepared to stop receiving electric energy from the off-board power source. A sensor may provide feedback to the controller confirming that the contactors or switches are open. In one or more embodiments, when the current of the collector device is below a predetermined threshold, the link voltage may be adjusted to an engine only mode level. In one example, the current of the collector device may be below the predetermined threshold when the current of the collector device is 30 amperes (A) or below, and thereby the onboard power sources may be the only source of electric energy to the vehicle loads. The engine only mode level may be the link voltage used when the engine (or other onboard power source) is the primary power source of the vehicle. At step 708, the method may include retracting the collector device toward the vehicle, and completing the disconnection of the collector device from the conductive pathway.

In one or more embodiments, the vehicle may disconnect from the conductive pathway and transition out of the trolley mode responsive to one or more of a release of the accelerator pedal below a minimum required level, movement of the directional lever out of an “UP” position such that the collector device moves away from the conductive pathway, if the speed of movement of the vehicle drops below a determined threshold (e.g., 5 mph, 3 mph, or the like), if the vehicle is able to only operate on a single inverter or a single motor, if the route is damaged causing movement of the collector device (e.g., the pantograph may bounce away from the conductive pathway, or the like), or the like. In one example, the vehicle may exit the trolley mode or disconnect from the conductive pathway after the vehicle has detected between about 30 milliseconds (MS) to about 50 MS of line bounce.

In one or more embodiments, the vehicle may experience an abnormal disconnection of the collector device from the conductive pathway. The abnormal disconnection may occur when a disconnection occurs abruptly and the operator or the controller of the vehicle may have limited time to react to the disconnection. During the abnormal disconnection, the second converter system may ignore link voltage targets or other determined thresholds that are monitored and maintained during normal connection, normal disconnection, and operation. In one embodiment, the first step may be to command an engine speed to a full rated speed, as well as reducing a traction torque of a motor. In one example, the engine may reach 1000 HP in 300 ms. The traction torque of the motor may be reduced to a minimum value. Reducing the traction torque of the motor toward zero or no traction power may reduce a load interruption by a circuit interruption device.

One or more sensors of the vehicle may measure a current of the collector device, such as after a fixed amount of time. In one example, the fixed amount of time may be 200 ms. The current may be measured to determine whether a first electric energy exceeds a designated threshold.

If the current of the collector device is above the designated threshold, for example 250A, a circuit interruption device may be opened. In one example, opening the circuit interruption device may include indirectly tripping a high-speed circuit breaker (HSCB) of the vehicle (e.g., switch 412A shown in FIG. 4). Where the current running through the collector device is high, for example above 250A, and the vehicle may disconnect from the conductive pathway, this large current could cause an arc that may damage the components of the collector device and vehicle. However, the HSCB may be designed to handle such an arc and direct the current with the indirect trip. Thus, the HSCB may be damaged by the arc, but the HSCB may be replaced without having to replace the entirety of the collector device. The HSCB may be tripped by adding a device that is mechanically separate from the HSCB. When tripped, the device may pull an arm of the HSBC which may release fingers and activate a spring. This may force the HSCB to open. In one example, the HSCB may have an internal protection which may allow the HSCB to open if the current is above an upper limit. In one example, the upper limit may be 2500A.

In one or more embodiments, one or more contactors of the collector control system may be opened. Once the vehicle has received feedback confirming that the contactors are open, the method may include moving the collector device. In one example, moving the collector device may include lowering a pantograph from the conductive pathway. In another example, moving the collector device may include moving a conductive shoe away from the conductive pathway.

While one or more embodiments are described in connection with a rail vehicle system, not all embodiments are limited to rail vehicle systems. Unless expressly disclaimed or stated otherwise, the subject matter described herein extends to other types of vehicle systems, such as automobiles, trucks (with or without trailers), buses, marine vessels, aircraft, mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy).

In accordance with one example or aspect of the subject matter described herein, a method for connecting to an external source includes determining that a vehicle to be propelled by a drive system having one or more motors is to connect to an off-board power source while the one or more motors are powered by an onboard power source. The onboard power source is controlled to provide a determined amount of first electric energy to a first converter system. A second converter system is controlled to output an amount of second electric energy from the off-board power source within a designated threshold range. The second converter system is disposed between the off-board power source and the first converter system. The drive system receives power from the off-board power source responsive to the second converter system outputting the second amount of electric energy within the designated threshold range.

Optionally, the designated threshold range may be based at least in part on a voltage of the off-board power source. Optionally, the method may include powering the drive system of the vehicle via the onboard power source until the second converter system outputs the amount of second electric energy that is within the designated threshold range. Optionally, the amount of first electric energy provided by the onboard power source may be based at least in part on a voltage capability of the off-board power source. Optionally, the method may include automatically transitioning from the onboard power source providing power to control operation of the vehicle to the off-board power source providing the power to control operation of the vehicle responsive to the second converter system outputting the second amount of electric energy that is within the designated threshold range. Optionally, the amount of the first electric energy supplied by the onboard power source may be controlled to be less than a power capability of the off-board power source, and thereby to reduce an amount of power generated by the one or more motors that are electrically coupled to the drive system. Optionally, the onboard power source may include an engine, and an engine speed of the engine may be increased to a designated speed to provide the determined amount of the first electric energy to the first converter system.

Optionally, an extended height of a pantograph may be controlled relative to an adjacent catenary, or a distance of a conductive shoe of the vehicle may be controlled relative to an electrified conductive body. The catenary and the electrified conductive body may extend along a route being traveled by the vehicle. Optionally, one or more switches disposed along conductive paths between the pantograph or the conductive shoe of the vehicle and the second converter system may be controlled to close responsive to the onboard power source providing the determined amount of first electric energy to the first converter system. Optionally, an electric current conducted from the one or more of the pantograph or the conductive shoe may be monitored responsive to closing the one or more switches.

In accordance with one example or aspect of the subject matter described herein, a method includes determining that a vehicle that is to be propelled by a drive system having one or more motors is to disconnect from an off-board power source while the one or more motors are being powered by the off-board power source. An onboard power source is controlled to provide a determined amount of first electric energy to a first converter system. A second converter system is controlled to output an amount of second electric energy from the off-board power source within a designated threshold range. The designated threshold range is less than the amount of first electric energy of the onboard power source. The drive system receives power from the onboard power source responsive to the second converter system outputting the second amount of electric energy within the designated threshold range.

Optionally, one or more switches disposed along conductive paths between a pantograph or a conductive shoe of the vehicle and the second converter system may be controlled to open responsive to the onboard power source providing the amount of first electric energy to the first converter system. Optionally, an electric current conducted from the one or more of the pantograph or the conductive shoe may be monitored subsequent to opening the one or more switches. Optionally, an extended height of the pantograph relative to an adjacent catenary or a distance of the conductive shoe relative to an electrified conductive body may be controlled. The catenary and the electrified conductive body may extend along a route being traveled by the vehicle.

Optionally, the onboard power source may include an engine, and an engine speed of the engine may be increased to a designated speed, a torque output by the one or more motors may be reduced, and/or the engine speed may be increased to the designated speed and the torque output by the one or more motors may be reduced.

In accordance with one example or aspect of the subject matter described herein, a system includes a vehicle that is to be propelled by an electric drive system having one or more motors. The vehicle is to be powered by one of a first electric energy from an onboard power source or a second electric energy from an off-board power source. A collector device is coupled to the vehicle, and the vehicle receives the second electric energy from the off-board power source via the collector device. A controller having one or more processors controls the onboard power source to provide a determined amount of the first electric energy to a first converter system while the vehicle is being powered by the first electric energy of the onboard power source. The controller controls a second converter system to output an amount of second electric energy from the off-board power source. The second converter system is disposed between the off-board power source and the first converter system. The drive system receives power from the off-board power source responsive to the second converter system outputting the second amount of electric energy within the designated threshold range.

Optionally, the system may include one or more switches disposed along conductive paths between a pantograph or a conductive shoe of the vehicle and the second converter system. The controller may close one or more of the switches responsive to the onboard power source providing the determined amount of the first electric energy to the first converter system. Optionally, the off-board power source may automatically provide the second electric energy to control operation of the vehicle responsive to the second converter system outputting the second amount of electric energy within the designated threshold range. Optionally, the onboard power source may include one or more of a fuel cell, battery cells, a capacitor bank of one or more capacitors, an engine, or one or more motors dynamically braking to generate the first electric energy from the onboard power source without the vehicle also braking using one or more friction brakes. Optionally, the controller may control a position of the collector device relative to one or more of a catenary or an electrified conductive body. The catenary and the electrified conductive body may extend along a route being traveled by the vehicle.

With regard to the fuel, the fuel may be a single fuel type in one embodiment and in other embodiments the fuel may be a mixture of a plurality of different fuels. In one example of a fuel mixture, a first fuel may be liquid and a second fuel may be gaseous. A suitable liquid fuel may be diesel (regular, biodiesel, HDRD, and the like), gasoline, kerosene, dimethyl ether (DME), alcohol, and the like. A suitable gaseous fuel may be natural gas (methane) or a short chain hydrocarbon, hydrogen, ammonia, and the like. In one embodiment, fuel may be inclusive of stored energy as used herein. In that perspective, a battery state of charge, or a source of compressed gas, a flywheel, fuel cell, and other types of non-traditional fuel sources may be included.

Use of phrases such as “one or more of . . . and,” “one or more of . . . or,” “at least one of . . . and,” and “at least one of . . . or” are meant to encompass including only a single one of the items used in connection with the phrase, at least one of each one of the items used in connection with the phrase, or multiple ones of any or each of the items used in connection with the phrase. For example, “one or more of A, B, and C,” “one or more of A, B, or C,” “at least one of A, B, and C,” and “at least one of A, B, or C” each can mean (1) at least one A, (2) at least one B, (3) at least one C, (4) at least one A and at least one B, (5) at least one A, at least one B, and at least one C, (6) at least one B and at least one C, or (7) at least one A and at least one C.

As used herein, an element or step recited in the singular and proceeded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended clauses, the terms “including” and “in which” are used as the plain-English equivalents of the respective terms “comprising” and “wherein.” Moreover, in the following clauses, the terms “first,” “second,” and “third,” etc. are used merely as labels, and do not impose numerical requirements on their objects. Further, the limitations of the following clauses are not written in means-plus-function format and are not intended to be interpreted based on 35 U.S.C. § 112(f), unless and until such clause limitations expressly use the phrase “means for” followed by a statement of function devoid of further structure.

The above description is illustrative, and not restrictive. For example, the above-described embodiments (and/or aspects thereof) may be used in combination with each other. In addition, many modifications may be made to adapt a particular situation or material to the teachings of the subject matter without departing from its scope. While the dimensions and types of materials described herein define the parameters of the subject matter, they are exemplary embodiments. Other embodiments will be apparent to one of ordinary skill in the art upon reviewing the above description. The scope of the subject matter should, therefore, be determined with reference to the appended clauses, along with the full scope of equivalents to which such clauses are entitled.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the clauses, and may include other examples that occur to one of ordinary skill in the art. Such other examples are intended to be within the scope of the clauses if they have structural elements that do not differ from the literal language of the clauses, or if they include equivalent structural elements with insubstantial differences from the literal languages of the clauses.

What is claimed is:

1. A method for connecting to an external source, comprising:
determining that a vehicle configured to be propelled by a drive system having one or more motors is configured to connect to an off-board power source while the one or more motors are powered by an onboard power source;
controlling the onboard power source to provide a determined amount of first electric energy to a first converter system; and
controlling a second converter system to output an amount of second electric energy from the off-board power source within a designated threshold range, the second converter system disposed between the off-board power source and the first converter system, wherein the drive system is configured to receive power from the off-board power source responsive to the second converter system outputting the second amount of electric energy within the designated threshold range.

2. The method of clause 1, wherein the designated threshold range is based at least in part on a voltage of the off-board power source.

3. The method of clause 1, further comprising powering the drive system of the vehicle via the onboard power source until the second converter system outputs the second amount of the second electric energy that is within the designated threshold range.

4. The method of clause 1, wherein the amount of the first electric energy provided by the onboard power source is based at least in part on a voltage capability of the off-board power source.

5. The method of clause 1, further comprising automatically transitioning from the onboard power source providing power to control operation of the vehicle to the off-board power source providing power to control operation of the vehicle responsive to the second converter system outputting the second amount of electric energy that is within the designated threshold range.

6. The method of clause 1, further comprising controlling the amount of the first electric energy supplied by the onboard power source to be less than a power capability of the off-board power source, and thereby reducing an amount of power generated by the one or more motors that are electrically coupled to the drive system.

7. The method of clause 1, wherein the onboard power source includes an engine, and further comprising increasing an engine speed of the engine to a designated speed to provide the determined amount of the first electric energy to the first converter system.

8. The method of clause 1, further comprising controlling one or more of (i) an extended height of a pantograph relative to an adjacent catenary or (ii) a distance of a conductive shoe of the vehicle relative to an electrified conductive body, wherein one or more of the catenary or the electrified conductive body extend along a route being traveled by the vehicle.

9. The method of clause 8, further comprising controlling one or more switches disposed along conductive paths between the one or more of the pantograph or the conductive shoe of the vehicle and the second converter system to close responsive to the onboard power source providing the determined amount of the first electric energy to the first converter system.

10. The method of clause 8, further comprising monitoring an electric current conducted from the one or more of the pantograph or the conductive shoe responsive to closing the one or more switches.

11. The method of clause 8, further comprising:
controlling operation of the vehicle with the second electric power received from the off-board power source;
detecting an oscillation of a voltage of the second electric energy from the off-board power source, the oscillation of the voltage changing an inductance of the second electric energy received by the second converter system; and
dampening the oscillation of the voltage with one or more of the first converter system or the second converter system.

12. A method, comprising:
determining that a vehicle configured to be propelled by a drive system having one or more motors is configured to disconnect from an off-board power source while the one or more motors are being powered by the off-board power source;
controlling an onboard power source to provide a determined amount of first electric energy to a first converter system; and
controlling a second converter system to output an amount of second electric energy from the off-board power source within a designated threshold range, the designated threshold range being less than the amount of the first electric energy of the onboard power source, the drive system configured to receive power from the onboard power source responsive to the second converter system outputting the second amount of electric energy within the designated threshold range.

13. The method of clause 12, further comprising controlling one or more switches disposed along conductive paths between one or more of a pantograph or a conductive shoe of the vehicle and the second converter system to open responsive to the onboard power source providing the determined amount of the first electric energy to the first converter system.

14. The method of clause 13, further comprising monitoring an electric current conducted from the one or more of the pantograph or the conductive shoe subsequent to opening the one or more switches.

15. The method of clause 13, further comprising controlling one or more of (i) an extended height of the pantograph relative to an adjacent catenary or (ii) a distance of the conductive shoe relative to an electrified conductive body, wherein the one or more of the catenary or the electrified conductive body extend along a route being traveled by the vehicle.

16. The method of clause 12, wherein the onboard power source includes an engine, and further comprising increasing an engine speed of the engine to a designated speed, reducing a torque output by the one or more motors, or both increasing the engine speed to the designated speed and reducing the torque output by the one or more motors.

17. A system, comprising:
a vehicle configured to be propelled by an electric drive system having one or more motors, the vehicle configured to be powered by one of a first electric energy from an onboard power source or a second electric energy from an off-board power source;
a collector device coupled to the vehicle, the vehicle configured to receive the second electric energy from the off-board power source via the collector device; and
a controller having one or more processors configured to control the onboard power source to provide a determined amount of the first electric energy to a first converter system while the vehicle is being powered by the first electric energy of the onboard power source,
the controller configured to control a second converter system to output an amount of the second electric energy from the off-board power source within a designated threshold range, the second converter system disposed between the off-board power source and the first converter system, wherein the drive system is configured to receive power from the off-board power source responsive to the second converter system outputting the second amount of electric energy within the designated threshold range.

18. The system of clause 17, further comprising one or more switches disposed along conductive paths between one or more of a pantograph or a conductive shoe of the vehicle and the second converter system, the controller configured to close one or more of the switches responsive to the onboard power source providing the determined amount of the first electric energy to the first converter system.

19. The system of clause 17, wherein the off-board power source is configured to automatically provide the second electric energy to control operation of the vehicle responsive to the second converter system outputting the second amount of electric energy within the designated threshold range.

20. The system of clause 17, wherein the onboard power source includes one or more of a fuel cell, battery cells, a capacitor bank of one or more capacitors, an engine, or one or more motors dynamically braking to generate the first electric energy from the onboard power source without the vehicle also braking using one or more friction brakes.

21. The system of clause 17, wherein the controller is configured to control a position of the collector device relative to one or more of a catenary or an electrified conductive body, wherein one or more of the catenary or the electrified conductive body extends along a route being traveled by the vehicle.
